(19) United States
(12) Patent Application Publication
(10) Pub. No.: US 2008/0071401 A1
(43) Pub. Date: Mar. 20, 2008

(54) AUDIO PLAYER CAPABLE OF PLAYING MULTIPLE MULTIMEDIA FILES SIMULTANEOUSLY

(75) Inventors: SHIH-FANG WONG, Tu-Cheng (TW); YI-FENG WENG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/855,123

(22) Filed: Sep. 13, 2007

(30) Foreign Application Priority Data
Sep. 14, 2006 (CN) 200610200871.3

(51) Int. Cl. G06F 17/00; H04B 1/00; H04B 3/00

(52) U.S. Cl. 700/94; 381/119; 381/120; 381/80

(57) ABSTRACT

An audio player capable of allowing multiple persons to listen to different multimedia files simultaneously is provided. The audio player includes a processing unit and a plurality of output channels. Each of the output channels is configured for outputting multimedia files. Each of the output channels includes a codec, an amplifier, and an audio output port. The amplifier is connected to the codec and the audio output port. The processing unit is connected with the output channels. The processing unit is configured for establishing a plurality of processes and for controlling performance of the processes according to time division multiplexing (TDM) technology. Wherein, each of the processes is configured for playing multimedia files and is assigned with one of the output channels for outputting the multimedia files.

### BACKGROUND

1. Technical Field

The present invention relates to audio players, and particularly to an audio player capable of playing multiple multimedia files simultaneously.

2. General Background

Portable music players such as MP3 players are popular devices to play music and other MP3 compatible documents.

Referring to FIG. 5, a conventional MP3 player is generally equipped with a codec, an amplifier, and an audio output port. These components form one output channel for outputting sound. The conventional MP3 player allows a single person to listen to music through the one output channel. However, the conventional MP3 player does not allow more than one person to listen to more than one musical file independently and simultaneously.

What is needed, therefore, is an audio player capable of playing multiple multimedia files simultaneously and allowing multiple persons to listen to each multimedia files independently and simultaneously.

### SUMMARY

An audio player is provided. The audio player includes a processing unit and a plurality of output channels. Each of the output channels is configured for outputting multimedia files. Each of the output channels includes a codec, an amplifier, and an audio output port. The amplifier is connected to the codec and the audio output port. The processing unit is connected with the output channels. The processing unit is configured for establishing a plurality of processes and for controlling performance of the processes according to time division multiplexing (TDM) technology. Wherein, each of the processes is configured for playing multimedia files and is assigned with one of the output channels for outputting the multimedia files.

Other advantages and novel features will be drawn from the following detailed description with reference to the attached drawing.

### BRIEF DESCRIPTION OF THE DRAWINGS

FIG. 1 is a schematic diagram of an appearance of an audio player in accordance with a preferred embodiment of the present invention;

FIG. 2 is a block diagram of hardware infrastructure of the audio player of FIG. 1;

FIG. 3 is a flowchart showing performance of multiple processes performed by the audio player of FIG. 2;

FIG. 4 is a schematic diagram of a control panel of the audio player of FIG. 1 in accordance with a preferred embodiment of the present invention; and

FIG. 5 is a schematic diagram of hardware infrastructure of a conventional audio player.

### DETAILED DESCRIPTION OF THE EMBODIMENT

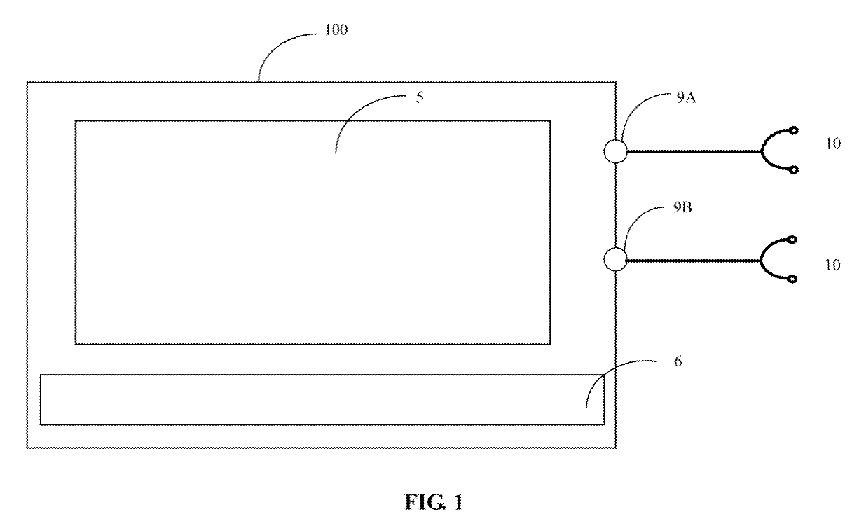

FIG. 1 is a schematic diagram of an audio player in accordance with a preferred embodiment of the present invention. The audio player 100 is equipped with a plurality of audio output ports 9. For example, in the embodiment as shown in FIG. 1, two audio output ports 9A, 9B are shown. Each of the two audio output ports 9A, 9B is configured for connecting to a transducer 10, such as a speaker or an earphone. The audio player 100 is operable to play a corresponding multimedia file and to output audio of the corresponding multimedia file through a designated audio output port 9. In other words, each of the audio output ports 9 can output audio independent of each other. That is, the audio output ports 9 can output audio of same multimedia files or different multimedia files independent of each other simultaneously.

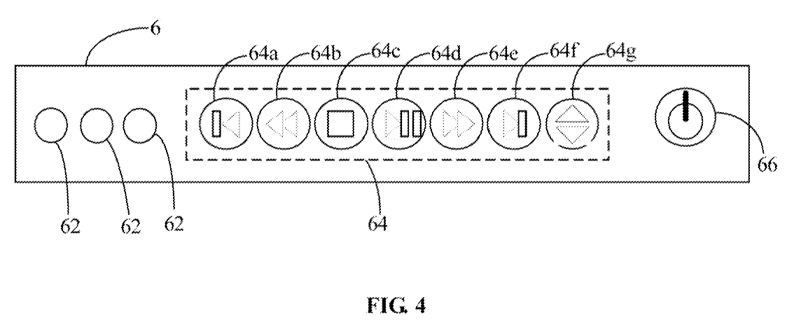

The audio player 100 is further equipped with a display unit 5 and a control panel 6. When the audio player 100 plays the multimedia files, the display unit 5 shows metadata of the played multimedia files that correspond to the selected audio output port(s) one after the other. For example, when an audio output port 9 is selected, the display unit 5 only shows a piece of metadata of the played multimedia file corresponding to the selected audio output port 9. When multiple audio output ports 9 are selected, for example, three audio output ports 9, the display unit 5 shows three pieces of metadata of the played multimedia files corresponding to the selected audio output ports 9 one by one. The control panel 6 is configured for generating instructions when receiving a user input. Referring to FIG. 4, the control panel 6 includes a plurality of port selection keys 62, a plurality of control buttons 64, and a power button 66.

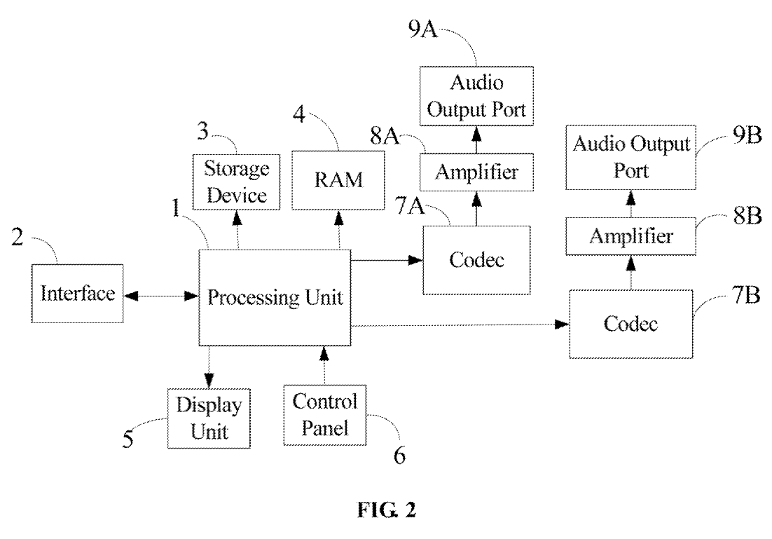

Each of the port selection keys 62 is assigned with a port ID and a specified output channel that is identified/assigned with an identification code. When the audio player 100 is turned off, each of the port selection keys 62 can be used as a switch for turning on the audio player 100 for music play. That is, each of the port selection keys 62 is configured for generating a signal to activate a processing unit 10 (see FIG. 2) to establish a corresponding process for playing corresponding multimedia files through the corresponding output channel. The corresponding process defines a plurality of process parameters for recording information related to the process. For example, the process parameters include a process identifier (ID) for identifying the process, the identification code of the corresponding output channel, and play parameters for running the process. The play parameters may include, but not limited to, a data path of the multimedia files, a flag indicating which one of the multimedia files is ready to be played, a play mode of the multimedia files (e.g., sequential play, loop play, single music loop play, random play, etc), a volume output of the multimedia files, and the like.

The control buttons 64 include, but not limited to, a foremost button 64a, an aftermost button 64f, a forward button 64e, a backward button 64b, a stop button 64c, a play/pause button 64d, and a volume adjustment button 64g. During listening to music, the user can press the control buttons 64 to reset the play parameters after pressing a corresponding port selection key 62. That is, during playing the multimedia files, the processing unit 10 determines which output channel is selected according to the pressed port selection key 62, and reset the associated play parameters corresponding to the determined output channel according to the control buttons 64.

The foremost button 64a is configured for activating the processing unit 10 to play a multimedia file which is listed firstly on a playlist, while theaftermost button 64f is configured for activating the processing unit 10 to play a multimedia file which is listed lastly on the playlist. The forward button 64e and the backward button 64b are configured for activating the processing unit 10 to play a next multimedia file and a previous multimedia file respectively. The stop button 64c is configured for activating the processing unit 10 to stop playing the multimedia file. The play/pause button 64d is configured for activating the processing unit 10 to play or pause the multimedia file. The volume adjustment button 64g is configured for increasing or decreasing volume output of the multimedia file.

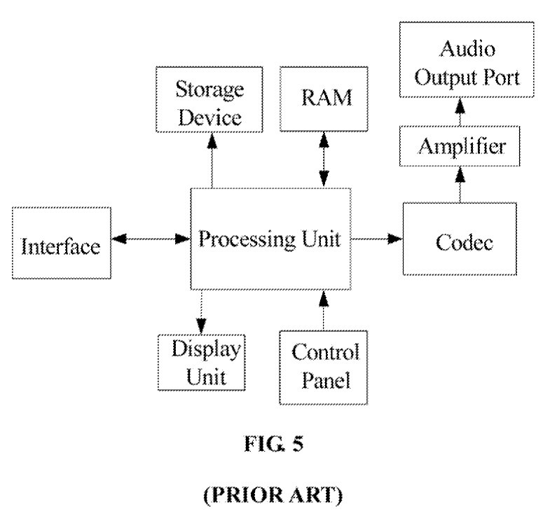

FIG. 2 is a block diagram of hardware infrastructure of the audio player 100 of FIG. 1 in accordance with a preferred embodiment of the present invention. As compared with the conventional audio player as that shown in FIG. 5, the audio player 100 includes a plurality of codecs 7, amplifiers 8, and audio output ports 9, which are operable to form multiple output channels. For simplicity, in the embodiment shown in FIG. 2, two codecs 7A, 7B, amplifiers 8A, 8B, and audio output ports 9A, 9B are shown.

Each of the codecs 7 is connected with the processing unit 10 and one of the amplifiers 8, and each of the amplifiers 8 is further connected with one of the audio output ports 9. In other words, one of the codecs 7, amplifiers 8, and audio output ports 9 make up one output channel for outputting the multimedia files. Further, each of the codecs 7 is assigned with the identification code that can be also used and regarded as the identification code of the corresponding output channel.

When one of the port selection keys 62 is selected, the processing unit 10 identifies the selected port selection key 62 according to the port ID, and selects the corresponding output channel for outputting the multimedia files according to the identification code assigned to the identified port selection key 62, thereby establishing the corresponding process for outputting the multimedia files.

That is, the processing unit 10 obtains corresponding play parameters associated with the established process from the storage device 3 according to the process ID of the established process, and temporarily stores the obtained play parameters in an random access memory (RAM) 4. The processing unit 10 further selects a corresponding codec 7, amplifier 8, and audio output port 9 (namely the corresponding output channel) according to the identification code associated with the selected port selection key 62, and controls playback of the multimedia files according to the obtained play parameters.

When another one of the port selection keys 62 is selected while the audio player 100 is playing the multimedia files (namely where the audio player 100 has a running process playing the multimedia files), the processing unit 10 establishes a new process corresponding to the new selected port selection key 62, and controls performance of these processes (e.g., the running process and the new process) according to time division multiplexing (TDM) technology.

In addition, the audio player 100 further provides a predetermined time for setting the play parameters after a selection operation of one of the port selection keys 62. That is, after one of the port selection keys 62 is selected, the processing unit 10 updates the corresponding play parameters in response to the user's operations (e.g., volume adjustment operation, multimedia file selection operation, etc.) on the control panel 6 in the predetermined time. In other words, when the user's operations are performed after the predetermined time, the processing unit 10 has no response to the user's operations.

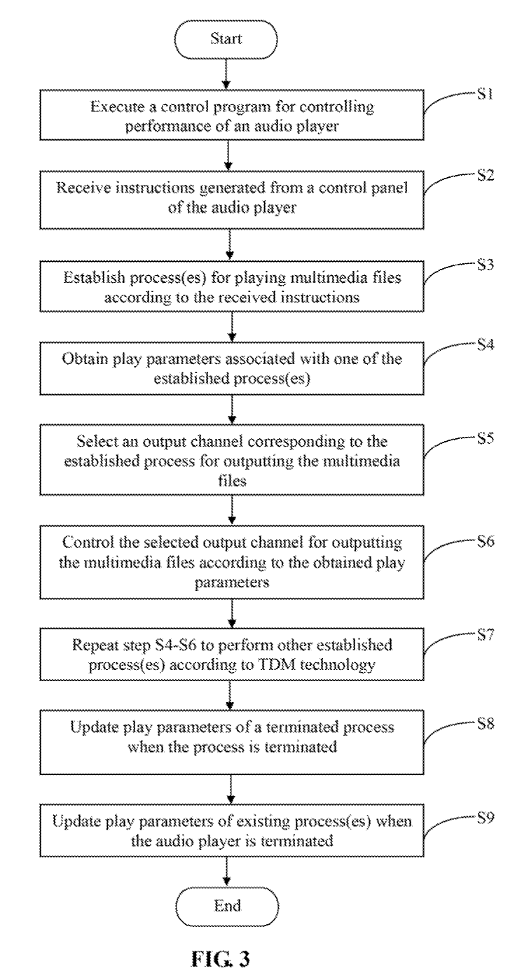

FIG. 3 is a flowchart showing performance of multiple processes performed by the audio player 100. In step S1, after the audio player 100 is powered on, the processing unit 10 invokes a controlling program for controlling performance of the audio player 100.

In step S2, the processing unit 10 receives the instructions generated from the control panel 6.

In step S3, the processing unit 10 processes the received instructions. For example, the processing unit 10 identifies the selected port selection key(s) 62 according to the port ID(s) and establishes the corresponding process(es) for playing the multimedia files.

In step S4, the processing unit 10 obtains the corresponding parameters associated with one of the established process(es) from the storage device 3, and temporarily stores the obtained play parameters in the RAM 4. In addition, if there are instructions for setting the play parameters following the instruction corresponding to the selection operation of one of the port selection keys 62, the processing unit 10 updates the play parameters in the RAM 4.

In step S5, the processing unit 10 selects the corresponding codec 7, amplifier 8, and audio output port 9 (namely the corresponding output channel) for outputting the corresponding multimedia files according to the identification code assigned to the established process.

In step S6, the processing unit 10 controls the selected codec 7, amplifier 8, and audio output port 9 to output the corresponding multimedia files according to the corresponding play parameters. The processing unit 10 further updates the corresponding play parameters (e.g., the flag indicating which multimedia files is ready to be played) after finishing playing a multimedia file.

In step S7, the processing unit 10 repeats the aforementioned steps S4-S6 to perform other established process(es) according to the TDM technology.

In step S8, when one of the established process(es) is terminated, the processing unit 10 obtains the play parameters of the terminated process and updates the play parameters in the storage device3 with the obtained play parameters from the RAM 4.

In step S9, when the audio player 100 is terminated, the processing unit 10 obtains the corresponding play parameters of the running process(es), and updates the corresponding play parameters in the storage device 3 with the obtained play parameters from the RAM 4 respectively.

The above performance of the steps S2-S9 is under the control of the control program.

Although the present invention has been specifically described on the basis of a preferred embodiment including a preferred method thereof, the invention is not to be construed as being limited thereto. Various changes or modifications may be made to the embodiment including the method without departing from the scope and spirit of the invention.

What is claimed is:

1. An audio player comprising:
a plurality of output channels, each of which comprises a codec, an amplifier, and an audio output port, wherein the amplifier is connected with the codec and the audio output port; and
a processing unit connected with the output channels, configured for establishing a plurality of processes and for controlling performance of the processes according to time division multiplexing (TDM) technology, wherein each of the processes is configured for playing multimedia files and is assigned with one of the output channels for outputting the multimedia files.

2. The audio player according to claim 1, wherein each of the output channels and the processes is assigned with an identification code and a process ID respectively, and each of the processes is associated with a plurality of process parameters, one of which is configured for recording the process ID and one of which is configured for recording the identification code of the output channel assigned to the process.

3. The audio player according to claim 2, further comprising a memory configured for storing the multimedia files and play parameters, wherein the output channels output the multimedia files according to the play parameters.

4. The audio player according to claim 1, further comprising a control panel configured for generating instructions of selecting output channels, wherein the processing unit establishes the processes according to the instructions.

5. The audio player according to claim 4, wherein the control panel is further configured for generating instructions of setting the play parameters.

6. The audio player according to claim 1, further comprising a display unit for displaying metadata of each of the played multimedia files in turn.
